(19) United States
(12) Patent Application Publication
(10) Pub. No.: US 2004/0184273 A1
(43) Pub. Date: Sep. 23, 2004

(54) Toilet night light

(76) Inventors: Daniel A. Reynolds, Deerfield Beach, FL (US); Barton F. Reynolds, Deerfield Beech, FL (US)

Correspondence Address: ROBERT M. DOWNEY, ROBERT M. DOWNEY, P.A., 601 SOUTH FEDERAL HIGHWAY, SUITE 300, BOCA RATON, FL, 33432, US

(21) Appl. No.: 10/393,633

(22) Filed: Mar. 20, 2003

(51) Int. Cl. F21V 23/04; F21L 4/00

(52) U.S. Cl. 362/394; 362/802; 362/191

(57) ABSTRACT

A night light device removably attaches to the underside of a toilet seat lid. When the lid is raised, light from a high-intensity LED is directed downwardly, at an angle, to illuminate the interior of the toilet bowl. The device is functional with the toilet seat in either the lowered or raised position to accommodate both male and female users. The device includes a timer circuit which, when energized, activates the LED. A switch is responsive to raised movement of the seat lid to energize the timer circuit for a fixed or adjustable time interval, so that the user can safely exit the bathroom, after using the toilet, with the assistance of the illuminating glow of the LED. At the end of the fixed or adjusted time interval, the device shuts off and remains in a default mode until reactivated by lifting the seat lid, thereby conserving battery power.

### BACKGROUND OF THE INVENTION

1. Field of the Invention

The present invention relates to a night light device and, more particularly, to a device which attaches to a toilet seat lid for illuminating the toilet bowl at night and without the necessity of activating the bathroom lights.

2. Discussion of the Related Art

Most people have the need to use the bathroom at least one time during the course of the night. In most instances, this requires activating the bathroom lights (e.g. incandescent or florescent lights). However, the intensity of the bathroom lights is often irritating to the eyes and causes temporary disorientation, as well as distortion of vision, particularly when a person is in a semi-sleep state in the middle of the night. And, by the time the person is finished using the bathroom, their eyes have adjusted to the bright lights and they are now fully awake. Then, upon exiting the bathroom and turning off the lights, it is difficult to find one's way safely back to bed due to the distorted vision caused by the bright bathroom lights. Additionally, because the person is now fully awake, it may be difficult to return to sleep. The need to switch on the bathroom lights when utilizing the toilet in the middle of the night can also be disturbing to others who are sleeping.

In the past, others have proposed various devices which are fitted to a toilet bowl or the toilet seat for illuminating the toilet without the need of activating the overhead bathroom lights. However, a major shortcoming of many of these devices is the failure to equally accommodate both male and female users. For instance, some of the devices in the prior art fail to illuminate the toilet when the toilet seat is in the lowered position and, therefore, provide no benefit to females. Additionally, all of the known prior art toilet light devices are fitted to either the underside of the seat or the porcelain toilet bowl and, as such, are generally unsanitary. Over time, these devices will inevitably become contaminated by contact with urine and fecal matter, presenting a serious health concern when it is necessary to change the batteries or replace the device. Further, the devices in the prior art are all deactivated, either manually or by raising or lowering the seat, once the person finishes using the toilet. Accordingly, the user of any of these prior art devices is required to exit the bathroom and find their way back to bed in the dark and without the assistance of any light.

### OBJECTS AND ADVANTAGES OF THE INVENTION

With the foregoing in mind, it is a primary object of the present invention to provide a toilet night light device which removably attaches to the underside of a toilet seat lid to direct light downwardly, at an angle, towards the toilet bowl, and wherein the device is adapted for use by both males and females.

It is a further object of the present invention to provide a toilet night light device which is operable to illuminate the toilet bowl and surrounding area when the toilet seat is either in a raised position or lowered position.

It is still a further object of the present invention to provide a toilet night light device which includes an integrated timer circuit which is energized for a fixed or adjusted time interval, thereby allowing the user to safely exit the bathroom while the device remains illuminated until the expiration of the fixed or adjusted time interval.

It is still a further object of the present invention to provide a toilet night light device which includes an integrated timer circuit for automatically deactivating the night light at the end of a fixed or adjusted time interval, thereby conserving battery power.

It is still a further object of the present invention to provide a toilet night light device which removably attaches to the underside of a toilet seat lid in a manner which is protected from exposure to contamination.

These and other objects and advantages of the present invention are more readily apparent with reference to the detailed description and drawings.

### SUMMARY OF THE INVENTION

The present invention is directed to a night light device which removably attaches to the underside of a toilet seat lid. A housing of the device positions a high-intensity LED to direction light downwardly and outwardly relative to the raised lid in order to illuminate the interior of the toilet bowl and the lowered toilet seat or the top rim of the bowl when the seat is in the raised position, thereby accommodating both male and female users. The device includes a timer circuit which, when energized, activates the LED. A switch is responsive to raised movement of the seat lid to energize the timer circuit for a fixed or adjustable time interval, so that the user can safely exit the bathroom, after using the toilet, with the assistance of the illuminating glow of the LED. At the end of the fixed or adjusted time interval, the device shuts off and remains in a default mode until reactivated by lifting the seat lid.

### BRIEF DESCRIPTION OF THE DRAWINGS

For a fuller understanding of the nature of the present invention, reference should be made to the following detailed description taken in conjunction with the accompanying drawings in which:

FIG. 1 is a front top perspective view of the toilet night light device of the present invention;

FIG. 2 is a side elevational view of the device;

FIG. 3 is a front perspective view showing the device installed on the underside of a toilet seat lid and activated to direct light downwardly into the toilet bowl and surrounding area;

FIG. 4 is a plan view showing the components within the housing of the device; and

FIG. 5 is an electrical schematic of the device components.

Like reference numerals refer to like parts throughout the several views of the drawings.

### DETAILED DESCRIPTION OF THE PREFERRED EMBODIMENTS

Referring to the several views of the drawings, the night light device of the present invention is shown and generally indicated as 10. The night light device 10 is intended for removable attachment to the underside 122 of a toilet seat lid 120 of a toilet bowl 100 so that light emitted from the device is directed downwardly into an interior 112 of the toilet bowl 100 and onto the surrounding area, such as the lowered seat 110 or the top rim of the toilet bowl 100.

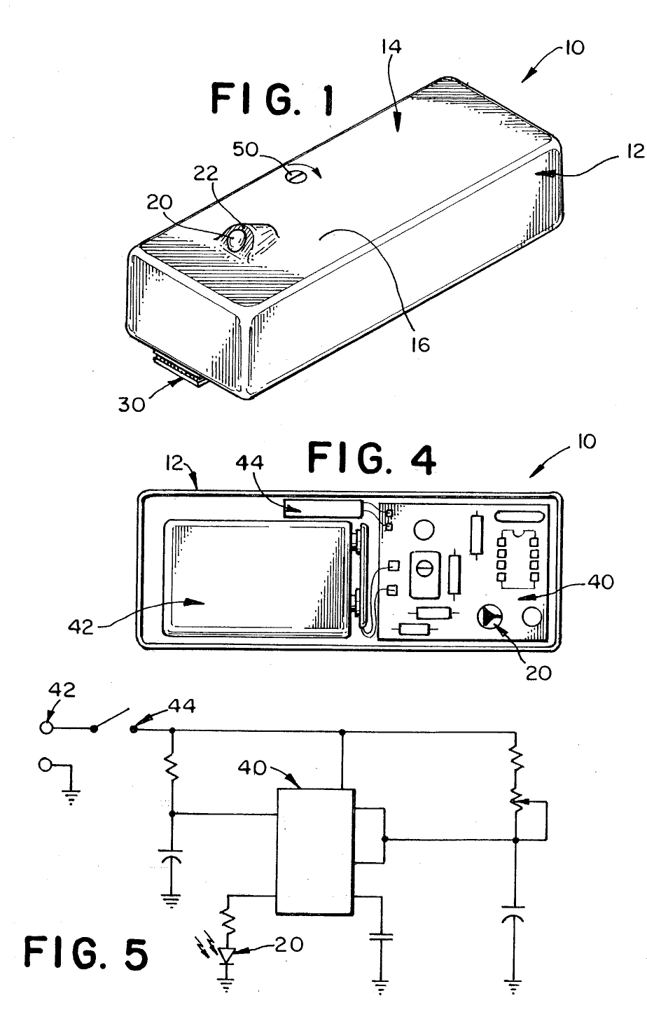

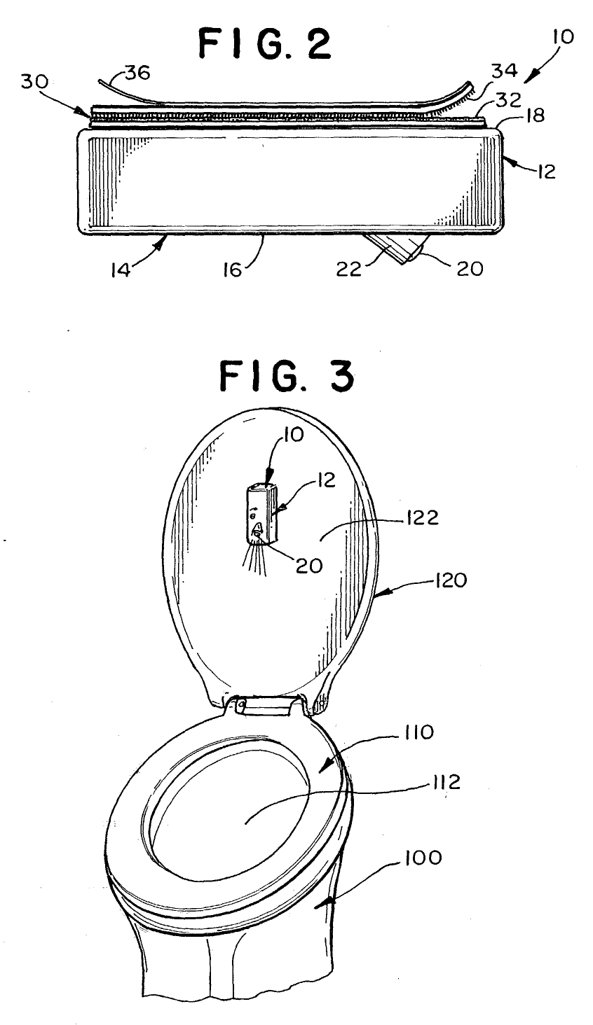

As seen in FIGS. 1-3, the night light device 10 includes an outer housing 12 including a front face 16 and a rear face 18. In a preferred embodiment, the housing includes a cover 14 which includes the front face 16 and surrounding sidewalls. The housing 12 is preferably formed of a plastic composition which can be conveniently molded in a high volume manufacturing operation.

A light-emitting source 20 is positioned and disposed on the front face 16 of the housing 12 in a manner which exposes the light-emitting source 20 so that light is directed downwardly and outwardly, at a slight angle, when the device 10 is fitted to the underside 122 of the toilet seat lid 120. In a preferred embodiment, a raised hub 22 is formed on the front face 16 of the housing 12 to support and position the light-emitting source 20 at an outward and downward angle relative to the front face 16 so that the light emitted therefrom is directed downwardly and outwardly relative to the lid 120 and into the toilet bowl 112, as described above. In a preferred embodiment, the light-emitting source is a high-intensity blue LED lamp. However, other suitable light-emitting devices of well known type are contemplated and intended to be within the spirit and scope of the invention.

As stated above, the device 10 removably attaches to the underside 122 of the toilet seat lid 120. To achieve this removable attachment, the present invention proposes the use of a hook and loop fastening system. Specifically, a hook component 32 is adhered to the rear face 18 of the housing 12 for mating, removable attachment to a loop component 34 attached to the underside 122 of the lid 120. Upon initial installation, a protective film 36 is removed from a rear side of the loop component 34 to expose an adhesive material. This permits attachment of the loop component 34 to the underside surface 122 of the lid, in the well known manner. Alternatively, a double-sided tape may be provided on the rear face of the housing to permit removable attachment of the device 10 to the underside 122 of the lid 120. Other suitable and well known means of removable attachment are contemplated within the spirit and scope of the invention.

Referring to FIGS. 4 and 5, a circuit of the device 10 is shown and includes an integrated timer circuit 40, a battery power source (e.g. nine-volt battery) 42, a non-mercury tilt trigger switch 44 and the LED lamp 20. In a preferred embodiment, the integrated timer circuit is a 555 integrated timer. The non-mercury tilt trigger switch 44 is normally open and is structured and disposed to operate to a closed state upon hinged movement of the lid 120 relative to the toilet bowl 100. The tilt trigger switch 44 may be structured and disposed to operate to the closed state upon sensing upward movement of the lid 120 from a lowered position to a raised position, as seen in FIG. 3. Alternatively, the tilt trigger switch 44 may be triggered to the closed state upon hinged downward movement of the lid 120. Still further, the tilt trigger switch 44 may be structured to operate to the closed state upon hinged movement of the lid 120 in either direction (i.e. upwardly or downwardly) relative to the toilet bowl 100. When the tilt trigger switch 44 is closed, a circuit is completed from the battery power source 42 to the integrated timer circuit 40. This causes the integrated timer circuit 40 to be energized for a period of time. The period of time may be fixed or adjustable by the user and/or manufacturer. In normal use, the integrated timer circuit should be energized for at least one minute and preferably no longer than ten minutes to conserve battery power. When the timer circuit 40 is energized, electric current flow is completed to the LED lamp 20, causing the LED lamp 20 to be illuminated. The LED lamp 20 remains illuminated throughout the period of time during which the integrated timer circuit 40 is energized. This allows a person to use the toilet and then safely exit the bathroom, on return to bed, with the assistance of the glow from the illuminated light source 20. At the expiration of the period of energized time of the integrated timer circuit 40 (either fixed or adjustable), the LED lamp 20 is deactivated. The integrated timer circuit 40 remains in a default mode until subsequently reenergized upon closing of the normally open tilt trigger switch 44.

As seen in FIG. 1, a screw 50 or other mechanism may be provided to remove the cover 14 of the housing in order to access the internal components of the circuit, and particularly the battery 42 when there is a need for battery replacement.

What is claimed is:

1. A night light device for removable attachment to the underside of a toilet seat lid on a toilet bowl comprising:
a housing including a front face and a rear face;
a circuit adapted for connection to an electric power supply and including:
a light-emitting source;
a movement actuated switch; and
a timer;
said light-emitting source positioned on said front face of said housing and being structured and disposed to direct light downwardly into an interior of the toilet bowl and an area surrounding the toilet bowl when the toilet seat lid is in a raised, generally vertical position;
said movement actuated switch being normally open and being structured and disposed to close upon movement of the toilet seat lid, thereby closing said circuit; and
said timer being energized for a period of time upon said circuit closing, and said timer being structured and disposed to activate said light-emitting source when energized, and said timer being further structured and disposed to deactivate said light-emitting source at the expiration of said period of time.

2. The device as recited in claim 1 further comprising:
means for removably attaching the device to the underside of the toilet seat lid.

3. The device as recited in claim 2 wherein said means for removably attaching the device to the underside of the toilet seat lid includes hook and loop fasteners.

4. The device as recited in claim 1 wherein said light-emitting source is an LED lamp.

5. The device as recited in claim 4 wherein said LED lamp is a high-intensity blue LED lamp.

6. The device as recited in claim 1 wherein said timer is an integrated timer circuit.

7. The device as recited in claim 1 wherein said movement actuated switch is a tilt trigger switch.

8. A night light device for removable attachment to the underside of a toilet seat lid on a toilet bowl comprising:
a housing;
a light-emitting source structured and disposed to direct light downwardly into an interior of the toilet bowl and an area surrounding the toilet bowl when the toilet seat lid is in a raised, generally vertical position;
a movement actuated switch structured and disposed to activate said light-emitting source upon movement of the toilet seat lid; and
a timer for deactivating said light-emitting source at the expiration of a period of time beginning at the activation of said light-emitting source.

9. The device as recited in claim 8 further comprising:
means for removably attaching the device to the underside of the toilet seat lid.

10. The device as recited in claim 9 wherein said means for removably attaching the device to the underside of the toilet seat lid includes hook and loop fasteners.

11. The device as recited in claim 8 wherein said light-emitting source is an LED lamp.

12. The device as recited in claim 11 wherein said LED lamp is a high-intensity blue LED lamp.

13. The device as recited in claim 8 wherein said timer is an integrated timer circuit.

14. The device as recited in claim 13 wherein said integrated timer circuit is structured and disposed to be energized for said period of time upon closing of said movement actuated switch.

15. The device as recited in claim 14 wherein said period of time is adjustable.

16. The device as recited in claim 8 wherein said movement actuated switch is a tilt trigger switch.
